(19) United States
(12) Patent Application Publication
(10) Pub. No.: US 2013/0186556 A1
(43) Pub. Date: Jul. 25, 2013

(54) Method for Manufacturing Bead Wire for Producing a Tire

(71) Applicant: Jean-Claude Soubrier, Romagnat (FR)

(72) Inventor: Jean-Claude Soubrier, Romagnat (FR)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 13/515,237

(22) PCT Filed: Dec. 7, 2010
(86) PCT No.: PCT/FR2010/052636

§ 371 Date: Oct. 2, 2012

(30) Foreign Application Priority Data
Dec. 9, 2009 (FR) 0958805

(51) Int. Cl. B29D 30/50

(52) U.S. Cl. CPC B29D 30/50
USPC 156/185; 156/580; 156/583.1

(57) ABSTRACT

In the method for manufacturing a bead wire intended for producing a tire, the bead wire comprises a coating that forms a region that overlaps itself in a circumferential direction of the bead wire. The bead wire is pressed using at least three jaws (8, 10, 12, 14) in contact with an entire perimeter of a section of the region.

The invention relates to the manufacture of bead wires intended for producing vehicle tires.

Tires comprise an annular reinforcing bead wire in each bead used for attaching the tire to the rim. In heavy goods vehicles, this bead wire comprises a metal reinforcement of rectangular cross section, coated with rubber to make the green tire easier to shape during manufacture. This coating is fitted onto the reinforcement in its circumferential direction. When the entire length of the reinforcement has been covered, the two circumferential ends of the coating are superposed forming an excess thickness.

Now, this geometric singularity gives rise to vibrations when the vehicle is driving along and so steps are taken to eliminate it. To do that it is possible to conceive of pressing the region of overlap between two jaws in a press. However, this pressing causes the rubber of which the coating is formed to flow between the jaws and that too generates geometric irregularities, and press residue.

It is an object of the invention to improve the way in which the geometric singularities of bead wires comprising a coating are treated.

To this end the invention provides a method for manufacturing a bead wire intended for producing a tire and comprising a coating that forms a region that overlaps itself in a circumferential direction of the bead wire, in which method the bead wire is pressed using at least three jaws in contact with an entire perimeter of a section of the region.

It is thus possible to have better control over the flow of the coating material, and this improves the evenness of the profile of the bead wire, along its circumference. That makes it possible to reduce the vibrations felt in the vehicle.

For preference, the number of jaws is at least four.

The bead wire can thus be pressed between each of the two pairs of jaws.

Advantageously, the bead wire is placed on one, the lower one, of the jaws.

For preference, the bead wire is pressed first of all by means of two mutually opposed jaws, preferably lower and upper jaws, while two more of the jaws, preferably lateral jaws are held away from the bead wire.

This then improves control over the flow of the material during pressing.

Advantageously, after the pressing between the two opposed jaws, these are immobilized with respect to the bead wire and the other two jaws are brought in closer to the bead wire.

For preference, after pressing between the two opposed jaws, the bead wire is pressed using all the jaws.

Advantageously, during pressing, a mark is made on the bead wire so that the two axial faces of the bead wire can be differentiated from one another.

Thus, during subsequent placement of the bead wires in a green tire, the operator will easily be able to recognize each of the two axial faces of each bead wire in order to orientate them appropriately within the green tire.

Advantageously, the bead wire comprises a reinforcement of polygonal cross section.

For preference, the coating comprises a padding layer and a cladding layer.

The invention also provides a press for a bead wire intended for producing a tire, the press comprising at least three jaws mounted with the ability to move relative to one another and able to form between them a closed-section cavity.

The press according to the invention may further exhibit at least any one of the following features:
it comprises an upper jaw, a lower jaw and two lateral jaws;
it comprises gear mounted with the ability to move with respect to one of the jaws, preferably a lower jaw, and which bears the other jaws.
within the gear, two of the jaws arranged to press the bead wire between them, preferably lateral jaws, are mounted with the ability to move relative to the third one;
the jaws are mounted with the ability to move in a sliding manner with respect to a frame of the press, and the cavity has a cross section exhibiting a main axis of symmetry that is inclined with respect to directions in which the jaws slide.
each jaw is coated with at least one nonstick layer; and
the press comprises means of heating the jaws.

Further features and advantages of the invention will become further apparent from the following description of one embodiment given by way of nonlimiting example with reference to the attached drawings in which:

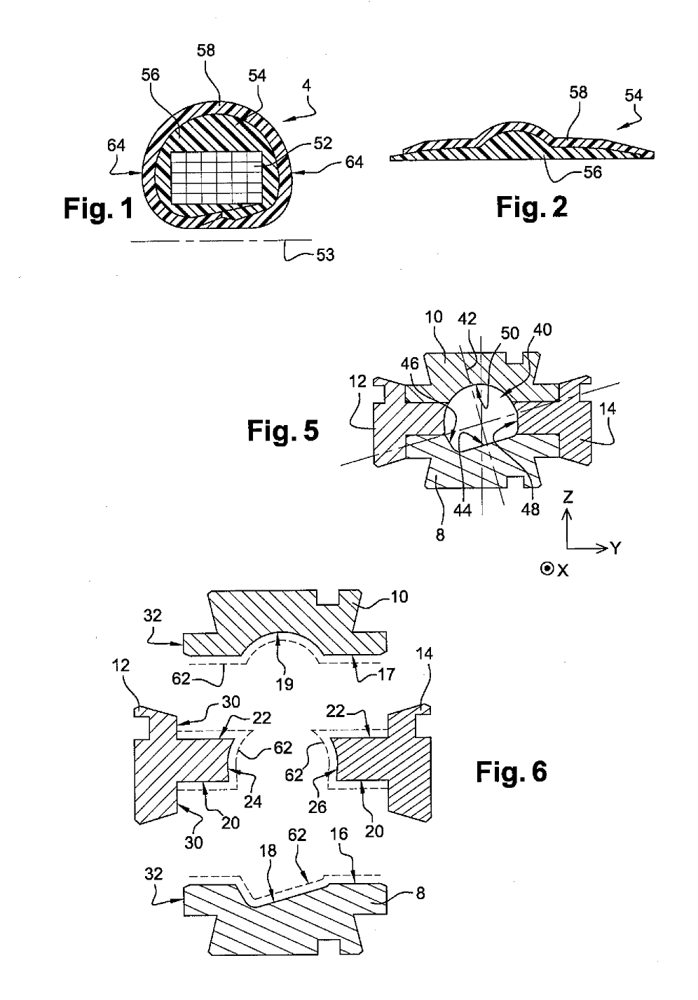

FIG. 1 is a view in cross section showing the main section of a bead wire before the method of the invention is implemented;

FIG. 2 is a view of the cross section of the coating of the bead wire of FIG. 1 before it is fitted onto the reinforcement thereof;

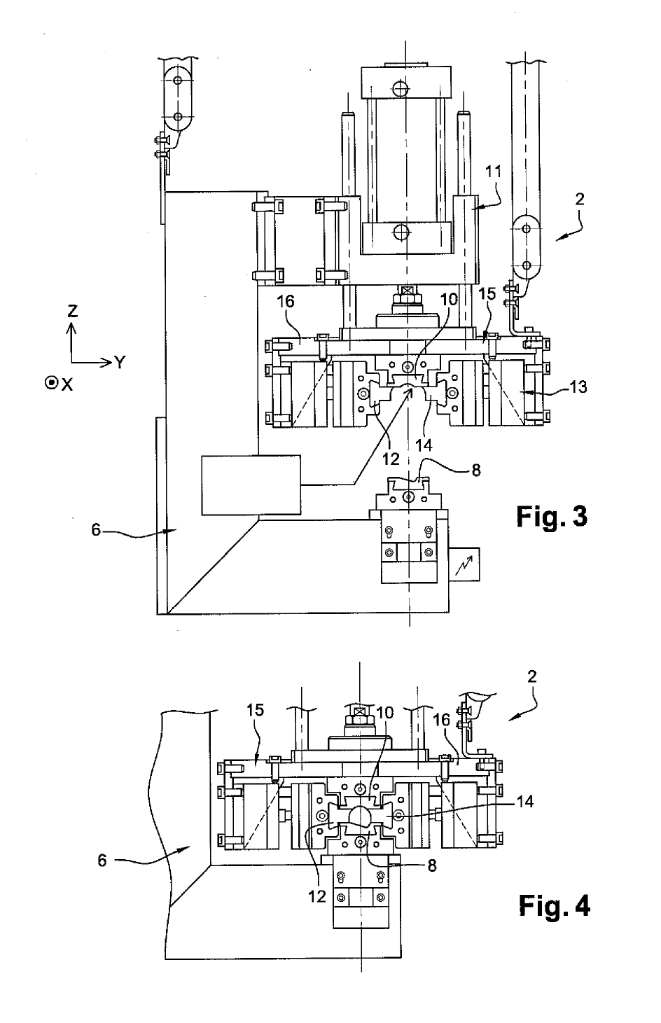

FIGS. 3 and 4 are two elevations of a press according to the invention, in the open state and in the closed state respectively;

FIGS. 5 and 6 are front views on a larger scale of the jaws of the press in closed and open positions respectively;

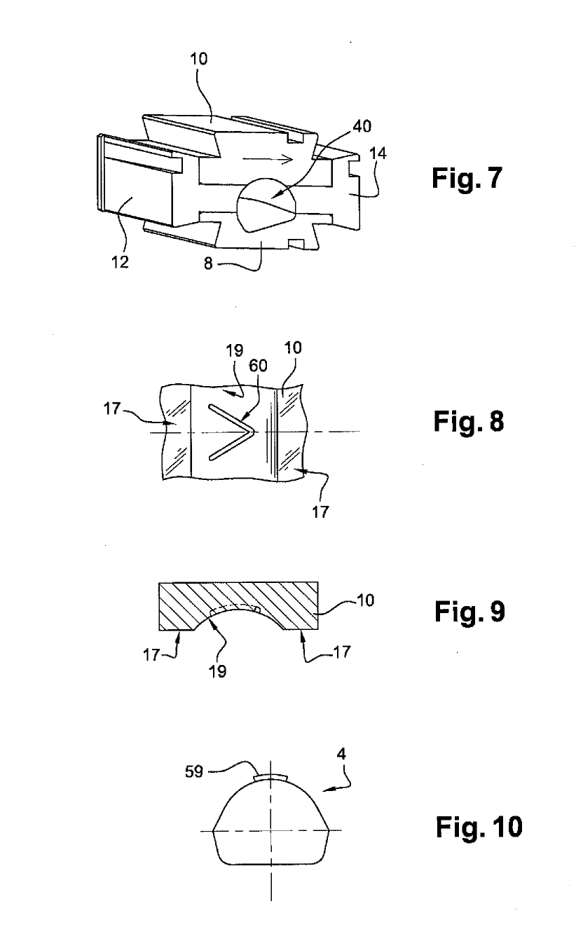

FIG. 7 is a perspective view of the jaws of FIG. 5;

FIGS. 8 and 9 are, respectively, views from beneath and in vertical section of the upper jaw of FIG. 5; and

FIG. 10 shows the shape of the cross section of the bead wire in its region of overlap after the method has been implemented.

In what follows, use will be made of an orthogonal frame of reference X, Y, Z in which the directions X and Y are horizontal and perpendicular to one another while the direction Z is vertical.

We shall first of all describe, with reference to FIGS. 3 to 9, the press 2 of the present embodiment of the invention. The press is used for manufacturing bead wires 4 which are themselves involved in the production of green tires for vehicles, for example heavy goods vehicles.

The press 2 comprises a fixed frame 6. This press is equipped with at least three jaws and in this particular instance with four jaws. Thus there is a lower jaw 8, an upper jaw 10, a left lateral jaw 12 and a right lateral jaw 14.

In this particular instance, the lower jaw 8 is fixed rigidly to the frame 6.

The press comprises gear 15 mounted with the ability to move in a sliding manner relative to the frame in the vertical direction Z. The gear 15 notably comprises a platen 16 which bears the upper jaw 10 and the two lateral jaws 12 and 14. The upper jaw 10 is rigidly fixed to the platen 16. The two lateral jaws 12 and 14 are each mounted with the ability to move in a sliding manner relative to the platen 16 in the direction Y and coaxially with respect to one another. The press comprises a pneumatic guidance unit 11 which moves the platen 16 in the vertical direction with respect to the frame, and a pneumatic guidance unit 13 which moves each of the lateral jaws with respect to the platen 16.

Each of the jaws is mounted removably with respect to the chassis so that it can easily be removed, refitted and, if need be, replaced. The press comprises means of heating each jaw, for example using electric cartridges, not illustrated. The press is thus capable of keeping each of the jaws at a temperature of, for example, between 120 and 150° C.

With reference notably to FIGS. 5 and 6, each of the lower 8 and upper 10 jaws has a horizontal planar main face 16, 17 interrupted in a central region by a shaping face 18, 19. The face 16 of the lower jaw faces upwards while the face 17 of the upper jaw faces downwards. Each of the lateral jaws 12 and 14 has a lower horizontal planar face 20 facing downwards, and an upper horizontal planar face 22 facing upwards. The faces 16 and 20 face one another, as do the faces 17 and 22. The horizontal faces 16 and 20 are designed to come into mutual surface-to-surface contact during operation of the press and so that each face 20 slides with respect to the face 16 in the direction Y. The same is true of the faces 17 and 22. The horizontal faces 20 and 22 of the left lateral jaw are each bounded on the left by a shoulder 30 that forms an end stop for edges 32 of the lower jaw 8 and of the upper jaw 10 respectively. This abutment therefore marks the end of travel of the left jaw 12 towards the right. The right lateral jaw 14 collaborates in the same way with faces of the lower and upper jaws to mark the end of travel to the left of the right lateral jaw 14.

The left lateral jaw 12 has a shaping face 24 delimited bottom and top by the faces 20 and 22 with which it forms corner edges. The same is true of the shaping face 26 of the right lateral jaw 14 in respect of the horizontal faces 20 and 22. The shaping faces 18 and 19 extend facing and some distance from one another. The same is true of the shaping faces 24 and 26.

The press is arranged so that, in the closed position, when the four jaws are in the configuration illustrated in FIG. 5 in which they are the closest to one another, the four shaping faces 18, 24, 19 and 26 form, in this order, a closed continuous succession which constitutes a cavity 40 open at its two axial ends in the direction X but closed in any vertical plane of section parallel to the directions Y and Z. The section in this plane is not circular but has a main axis of symmetry 42 that is inclined with respect to each of the directions Y and Z. The section notably has a straight base 44, two chamfers 46 and 48 extending from the ends of the base 44, and a concave curved arch 50 joining the ends of the chamfers. The shaping face 18 corresponds to the segment 44 and to the left chamfer 46. The arch 50 is defined by the faces 24 and 19. The face 26 defines a fraction of the arch and the left chamfer 48.

After they have been machined, each of the jaws is, in this instance, coated with at least one layer of a nonstick coating 62 such as the coating marketed under the reference FEP Xylan 8840/2618. In the present example, each jaw is coated with a primary coat of this product after having raised the jaw to a temperature of at least 120° C. Next, having raised its temperature to 400° C., a finishing coat of the same product is applied. The total thickness of the coats is between 20 and 30 microns. The coats extend over the faces 16, 20, 22 and 17 to make it easier for them to slide on one another and on the shaping faces.

The method of the invention is implemented here as follows.

It is assumed that an annular bead wire has been produced as illustrated in FIG. 1, the annulus having a main axis 53. The bead wire comprises a central reinforcement 52 forming the heart of the cross section. This reinforcement is made up of metal strands placed side by side and stacked, and has the overall shape of a polygon, for example of a quadrilateral and, in this instance, of a rectangle. The reinforcement 4 is provided with a coating 54 which in this particular instance comprises an internal padding layer 56 in contact with the reinforcement and an external cladding layer 58. In this instance, the two layers form a complex co-extruded product and each contain rubber. Prior to being fitted to the reinforcement 52, the coating 54 is laid out flat and has an open cross section illustrated in FIG. 2. During application, this section is wound around the cross section of the reinforcement. This fitting is done around the circumference of the reinforcement, which means locally its longitudinal direction. The two longitudinal ends of the coating therefore form a region of mutual overlap in the circumferential direction.

To shape this region of overlap the procedure is a follows.

The press is initially opened as illustrated in FIG. 3, namely the gear 16 is its uppermost position relative to the lower jaw 8. In addition, the lateral jaws 12 and 14 are in their position furthest apart from one another and from the upper jaw 10. The horizontal faces 22 and 17 are in contact over a fraction of their length.

The horizontal faces 16 and 20 are not in contact.

The bead wire 4 is placed in the press 2 with the region of overlap on the lower jaw 8 and the main axis 53 parallel to the direction Y.

The gear 15 is lowered to press the region of overlap of the bead wire between the lower 8 and upper 10 jaws. This region is pressed between these two jaws compressing the coating, causing it to flow in the direction Y towards the lateral jaws. During the lowering, the horizontal faces 16 and 20 come into contact with one another over a fraction of their surface.

Next, keeping the lower 8 and upper 10 jaws in position, the lateral jaws are 25 brought closer together and made to slide in the direction Y. During this movement, the faces 20 slide on the face 16 while remaining in surface-to-surface contact therewith. The same is true of the faces 22 in respect of the faces 17. The lateral jaws thus come into contact with the coating which they press between them. From the moment of this contact, the bead wire finds itself pressed simultaneously between the 30 four jaws. At the end of the movement of the jaws, the four shaping faces that make up the closed-section cavity 40 in which the region of overlap is pressed and heated between the four jaws as illustrated in FIGS. 4, 5 and 7. The rubber is therefore forced to spread by flowing in this section to adopt a male shape illustrated in FIG. 10 that corresponds to the female shape of the cavity 40. The pressure is maintained 35 in this position for a few seconds in order for the rubber to take its place.

The press is then opened. To do that, the lateral jaws 12 and 14 are moved apart from one another then the platen 16 is raised again, carrying with it the two lateral jaws and the upper jaw 10. The bead wire can then be taken out.

After pressing, the planar lower face of the reinforcement 52 is parallel to the lower face of the cross section of the bead wire as defined by the segment 44. The hot pressing also allows the coating to be welded to itself at its overlapping parts.

As illustrated in FIGS. 8 and 9, one of the jaws, in this instance the upper jaw 10, comprises a geometric singularity in the form of a relief or of a cavity. In this instance it is a cavity 60. This singularity has a position and/or shape that makes it possible to make a distinction between the two axial faces 64 of the bead wire following the shaping of the region of overlap. These faces 64 are perpendicular to the axis 53. In this instance, the cavity 60 is in the shape of a V, the axis of symmetry of the V being parallel to the direction Y. The cavity 60 extends into the tallest part of the shaping face 19. When the method is implemented, it allows a raised [symbol] V [symbol] mark 59 to be created at the top of the section of the region of overlap. This mark will allow the operator to position the bead wire in the green tire with a predetermined orientation of its axial faces 64.

The invention is applicable to the manufacture of tires for the wheels of vehicles of the light vehicle, heavy goods vehicle or construction plant type.

Of course, numerous modifications can be made to the invention without departing from its scope.

It is possible to conceive of the press having just three jaws.

The movements of the jaws, notably their direction and the order in which they move, could be modified.

1. A method for manufacturing a bead wire intended for producing a tire, wherein, with the bead wire comprising a coating that forms a region that overlaps itself in a circumferential direction of the bead wire, the bead wire is pressed using at least three jaws in contact with an entire perimeter of a section of the region.

2. The method according to claim 1, wherein the number of jaws is at least four.

3. The method according to claim 1, wherein the bead wire is pressed first of all by two of the jaws which are mutually opposed, while two more of the jaws, are held away from the bead wire.

4. The method according to claim 3, wherein after the pressing between the two opposed jaws, these are immobilized with respect to the bead wire and the other two jaws are brought in closer to the bead wire.

5. The method according to claim 3, wherein after pressing between the two opposed jaws, the bead wire is pressed using all the jaws.

6. The method according to claim 1, wherein during pressing, a mark is made on the bead wire so that the two axial faces of the bead wire can be differentiated from one another.

7. The method according to claim 1, wherein the bead wire comprises a reinforcement of polygonal cross section.

8. The method according to claim 1, wherein the coating comprises a padding layer and a cladding layer.

9. A press for a bead wire adapted for producing a tire, the press comprising at least three jaws mounted with the ability to move relative to one another and able to form between them a closed-section cavity.

10. The press according to claim 9, which comprises an upper jaw, a lower jaw and two lateral jaws.

11. The press according to claim 9, which comprises gear mounted with the ability to move with respect to one of the jaws, preferably a lower jaw, and which bears the other jaws.

12. The press according to claim 11, wherein within the gear, two of the jaws arranged to press the bead wire between them, preferably lateral jaws, are mounted with the ability to move relative to the third one.

13. The press according to claim 9, wherein the jaws are mounted with the ability to move in a sliding manner with respect to a frame of the press, and the cavity has a cross section exhibiting a main axis of symmetry that is inclined with respect to directions in which the jaws slide.

14. The press according to claim 9, wherein each jaw is coated with at least one nonstick layer.

15. The press according to claim 9, which comprises means of heating the jaws.
